(19) United States
(12) Patent Application Publication
(10) Pub. No.: US 2003/0076540 A1
(43) Pub. Date: Apr. 24, 2003

(54) Printer output image forming method and forgery preventing method

(75) Inventors: Mitsuhiro Hamashima, Shinjuku-Ku (JP); Kazuhiro Kawabata, Shinjuku-Ku (JP); Naoji Shibasaki, Tokyo-To (JP)

Correspondence Address: PARKHURST & WENDEL, L.L.P., 1421 PRINCE STREET, SUITE 210, ALEXANDRIA, VA, 22314-2805, US

(73) Assignee: DAI NIPPON PRINTING CO., LTD., Shinjuku-Ku (JP)

(21) Appl. No.: 10/270,320

(22) Filed: Oct. 15, 2002

(30) Foreign Application Priority Data
Oct. 16, 2001 (JP) 2001-317955

(51) Int. Cl. H04N 1/407; G06K 15/02

(52) U.S. Cl. 358/3.28; 358/1.14

(57) ABSTRACT

Input image data (3) and reproduction-restraining pattern data (2) are combined to obtain composite image data. A composite image represented by the composite image data is printed on an image-receiving sheet (10) by an on-demand printing system. A reproduction-restraining pattern (11) appears when the printed composite image is copied.

### TECHNICAL FIELD

The present invention relates to a printer output forming method and a forgery preventing method that put restraints on copying an image provided by a printer to prevent forgery.

### BACKGROUND ART

A printed sheet is provided with an invisible reproduction-restraining pattern. For example, two invisible dot patterns respectively having different dot pitches and having the same dot percentage are printed on a printed sheet such that contiguous parts of the two patterns have the same dot percentage. When the printed sheet is copied the dot pattern having the greater dot pitches becomes visible and discriminates the copy from the original printed sheet (JP-A No. 247089/1994).

Different copying machines have different resolution levels, respectively. An invention disclosed in JP-A No. 247088/1994 uses a plurality of patterns respectively having different resolution levels, and prints dots, line intervals or the thickness of intervals of a set of parallel lines arranged at intervals equal to twice the thickness in different gradations to facilitate identifying copies.

The foresaid printed sheets are printed in large quantities using an original plate. Therefore, the reproduction-restraining pattern is fixed, once the original plate is made. Therefore, another original plate must be made when the reproduction-restraining pattern needs to be changed.

Recently, there have been marketed printers capable of easily printing images corresponding to image data recorded on various digital media including PC cards, smart media, CD-ROMs and digital cameras. On-demand printers, i.e., large-scale printers, which are installed in convenience stores or places where people gather and capable of printing out images in response to a print start command given after depositing a predetermined charge, have been prevalently used in recent years.

Usually images printed by such printers are original images of individuals and it is requested that the images are not copied without permission. Photographs of stars, tickets and identification cards which are used to be printed by printing machines are printed by printers using digital image data. Therefore, it is very important to prevent the unpermitted copying and the forging of those printed images. Conventional reproduction-restraining patterns are not suitable for handy printers because those reproduction-restraining patterns are printed by using original plates.

### DISCLOSURE OF THE INVENTION

The present invention has been made to solve the foregoing problems and it is therefore an object of the present invention to provide a printer output forming method and a forgery preventing method to be carried out by a printing system that does not use any original plate, capable of a reproduction-restraining function and a forgery preventing function.

According to the present invention, a printer output image forming method comprises the steps of: preparing image data including a background pattern; preparing reproduction-restraining pattern data including a reproduction-restraining pattern; combining the image data and the reproduction-restraining pattern data to form a composite image data; and transferring a composite image including the background pattern and the reproduction-restraining pattern on the basis of the composite image data on a image-receiving sheet; wherein the transferred composite image is copied such that the reproduction-restraining pattern stands out against the background pattern.

In the printer output image forming method according to the present invention, the composite image is transferred to the image-receiving sheet by an on-demand printer system using a thermal transfer printing method, an ink-jet printing method or an electrophtographic recording method.

In the printer output image forming method according to the present invention, the reproduction-restraining pattern is formed by combining dense and coarse arrangements of lines or dots or by combining dots having different shades.

In the printer output image forming method according to the present invention, an additional different reproduction-restraining pattern is printed beforehand on the front or the back surface of the image-receiving sheet.

The printer output image forming method according to the present invention further comprises the step of forming an overcoating layer on the image-receiving sheet; wherein an additional reproduction-restraining pattern is printed beforehand on the overcoating layer.

In the printer output image forming method according to the present invention, the additional reproduction-restraining pattern is formed from lines or dots finer than the transferred reproduction-restraining pattern.

In the printer output image forming method according to the present invention, the overcoating layer formed on the image-receiving sheet has a hologram transfer part.

In the printer output image forming method according to the present invention, the reproduction-restraining pattern and the background pattern are formed by transferring dyes or pigments having different characteristics, respectively.

In the printer output image forming method according to the present invention, the reproduction-restraining pattern includes a warning message, date of issue, serial number, a designation, a logo or a concealed picture.

A printer output image forgery preventing method according to the present invention comprises the steps of: forming an image having an image pattern on an image-receiving sheet by a thermal transfer printing method; and superposing a transparent sheet carrying a predetermined discrimination pattern on the image formed on the image-receiving sheet such that the discrimination pattern is caused to appear by an moiré effect of superposition of the predetermined discrimination pattern on the image formed on the image-receiving sheet.

In the printer output image forgery preventing method according to the present invention, the image formed on the image-receiving sheet further includes a reproduction-restraining pattern.

In the printer output image forgery preventing method according to the present invention, the discrimination pattern includes a warning message, date of issue, serial number, a designation, a logo or a concealed picture.

A printer output image forgery preventing method according to the present invention of preventing the forgery of a printer output image formed on a recording sheet by a thermal transfer printing method uses fluorescent colors that cannot be reproduced by ordinary printers for forming the printer output image.

A printer output image forming apparatus according to the present invention comprises: a pattern data combining means for combining input image data including a background pattern, and a reproduction-restraining pattern data including that of a reproduction-restraining pattern to obtain a composite image data; and an output unit that provides the composite image data and prints a composite image including the background pattern and the reproduction-restraining pattern.

### BRIEF DESCRIPTION OF THE DRAWINGS

FIG. 1 is a block diagram of assistance in explaining a printer output image forming method in a preferred embodiment according to the present invention;

FIG. 2 is a view of a printed sheet carrying a reproduction-restraining pattern transferred thereto;

FIG. 3 is a view showing a background dot pattern and a reproduction-restraining dot pattern; and

FIG. 4 is a view of assistance in explaining a printer output image forgery preventing method in a preferred embodiment according to the present invention.

### BEST MODE FOR CARRYING OUT THE INVENTION

Preferred embodiment according to the present invention will be described hereinafter.

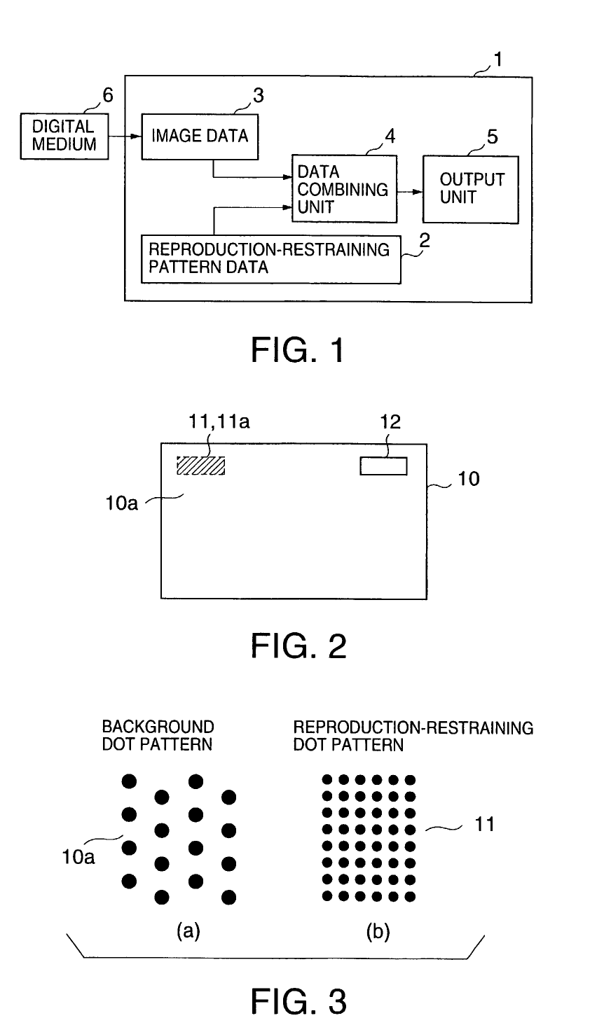

FIG. 1 is a block diagram of assistance in explaining a printer output image forming method in a preferred embodiment according to the present invention. Although preferred embodiments of the present invention will be described as applied to an on-demand printer system, the present invention is not limited in its practical application thereto and is applicable to optional printer systems.

An on-demand printer system 1 holds a reproduction-restraining pattern data 2. A data combining unit 4 combines image data 3 and reproduction-restraining pattern data 2 to provide a composite image data. An output unit 5 prints a composite image represented by the composite image data by a transfer printing method, such as a sublimation transfer printing method or a thermal transfer printing method. The reproduction-restraining pattern data 2 represents a reproduction-restraining pattern 11. The printed reproduction-restraining pattern 11 is visually unrecognizable. The image data 3 includes that of a background pattern 10a. The background pattern 10a is printed together with the reproduction-restraining pattern 11. When a user ticket issue menu is selected on the on-demand printer system 1 and fare is paid, image data 3 representing an image for a specified ticket is read from a hard disk, the image data 3 is combined with the reproduction-restraining pattern data 2 to provide a composite image data, and the background pattern 10a by the image data 3 is printed together with the reproduction-restraining pattern 11 on a recording sheet. The reproduction-restraining pattern data 2 does not need necessarily to be held by the on-demand printer system 1, but may be produced by the on-demand printer system 1 immediately before printing the composite image data.

FIG. 2 shows, byway of example, a printed sheet (printed image-receiving sheet) 10 carrying the reproduction-restraining pattern 11. As shown in FIG. 2, the reproduction-restraining pattern 11 is printed in an area outside or overlapping an image area of the surface of the printed sheet 10. The reproduction-restraining pattern 11 is visually unrecognizable. The background patter 10a is a coarse dot pattern of large dots as shown in FIG. 3(a), while the reproduction-restraining pattern 11 is a dense dot pattern of small dots as shown in FIG. 3(b). The background pattern 10a and the reproduction-restraining pattern 11 are the same in the sum of the areas of dots in a unit area. Therefore, it is difficult to recognize the reproduction-restraining patter 11 visually. When a reader having a resolving power and included in a copying machine is unable to read the dots of the reproduction-restraining pattern 11 correctly or when the reader is able to read the dots of the reproduction-restraining pattern 11 correctly but the copying machine is unable to record the reproduction-restraining patter 11 correctly, the reproduction-restraining pattern 11 consisting of the small dots cannot be correctly copied when the printed sheet 10 is copied. Consequently, parts corresponding to the dots of the reproduction-restraining pattern 11 in the printed sheet 10 become void, which is a proof of the copy. Although this printer output image forming method restrains copying by making the reproduction-restraining pattern 11 disappear to restrain copying, the printed sheet and a copy may be discriminated from each other by some pattern that is made to develop by a special operation like copying.

The size of the dots forming the reproduction-restraining pattern 11 is determined so as to conform to various copying machines respectively having different resolving powers. The size of the dots forming the reproduction-restraining pattern 11 is varied stepwise or continuously from position to position in a printing region so that the size of the dots corresponds to the different resolving powers of various copying machines. Thus, different parts, respectively corresponding to the different resolving powers of the copying machines, of the reproduction-restraining pattern 11 can be made obvious. The background patter 10a may be a dense dot pattern of small dots and the reproduction-restraining pattern 11 may be a coarse dot pattern of large dots. In this case, the background pattern 10a cannot be correctly copied, and the reproduction-restraining patter 11 becomes obvious. The reproduction-restraining pattern 11 may be formed by combining a set of coarsely arranged parallel lines and a set of densely arranged parallel lines. The reproduction-restraining pattern 11 may be formed by combining dots having different shades. Since a sublimation transfer printing method is capable of controlling the shade of each dot, a dot formed by printing two dots having a gradation of 128, and a dot formed by printing four dots of a gradation half that of the two dots have the same shade. The boundary between the reproduction-restraining pattern 11 and the background pattern 10a can be made obscure by combining dots respectively having different shades. An additional reproduction-restraining pattern 11a of fine lines may be printed on the image-receiving sheet 10 beforehand, and the coarse reproduction-restraining patter 11 may be formed on the image receiving sheet 10 by a transfer printing method to form a pattern consisting of the coarsely arranged lines and the densely arrange lines. There is not any restrictions on the shapes and colors of the reproduction-restraining patters 11 and 11a.

The present invention is not limited in its practical application to the foregoing embodiment and various modifications are possible. The present invention may be used in combination with other reproduction preventing techniques.

For example, a reproduction-restraining pattern 11 representing a logo may be printed beforehand on the front or the back surface of the image-receiving sheet 10, the reproduction-restraining pattern 11 may be printed on the image-receiving sheet 10 beforehand by a micro printing method, the reproduction-restraining pattern 11 may be formed by partly changing energy when the overcoating layer is transferred or a hologram 12 may be formed in the image-receiving sheet 10. The reproduction-restraining pattern 11 and the background pattern 10a may be formed by transfer printing using dyes or pigments having different characteristics, respectively.

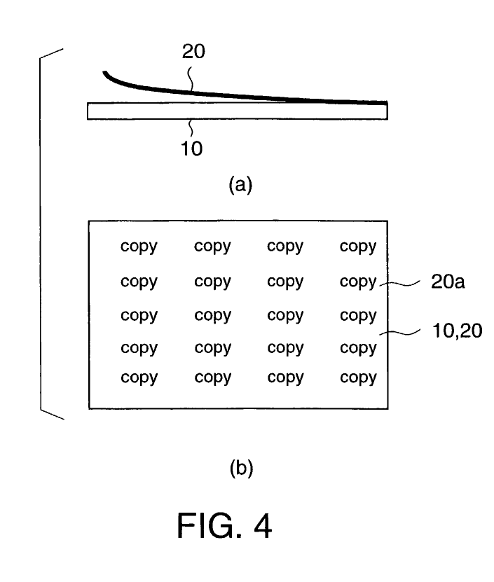

FIG. 4 is a view of assistance in explaining a printer output image forgery preventing method in a preferred embodiment according to the present invention.

A background pattern (image pattern) 10a as shown in FIG. 3(a) is printed on a printed sheet (image-receiving sheet) 10. A discrimination pattern 20a of a screen ruling or a dot angle different from that of the background pattern 10a shown in FIG. 3(a) is formed on the image-receiving sheet 10 such that, when a transparent sheet 20 is superposed on the printed sheet 10, words “copy” as shown in FIG. 4(b) are caused to appear by the moiré effect of superposition of the discrimination pattern 20a on the background pattern (image pattern) 10a. The arrangement of the words ‘copy’ is the discrimination pattern 20a to discriminate the printed sheet 10 from its copy. It is possible to provide the printed sheet 10 with a reproduction-restraining effect by printing a reproduction-restraining pattern 11 on the printed sheet 10. The transparent sheet 20, similarly to the printed sheet 10, can be printed by a print system.

The reproduction-restraining pattern 11 and the discrimination pattern 20a for forgery prevention may be an optional characters or patterns, such as a warning message, date of issue, serial number, a designation, a logo or a concealed picture. The present invention is applicable not only to reproduction-restraining but also to making a concealed picture become visible and to making an answer to a quiz to appear when the printed sheet 10 is copied or when a transparent sheet is superposed on the printed sheet 10.

A forgery preventing function can be achieved by using fluorescent colors that cannot be reproduced by ordinary printers for printing an image on the image-receiving sheet 10 by a thermal transfer printing method.

As apparent from the foregoing description, according to the present invention, it is possible to provide a printed sheet with a reproduction-restraining function and effects of a concealed picture simply by combining a reproduction-restraining pattern data produced by combining lines or dots of different densities and dots of different shades with image data of an image to be printed. It is possible to provide a printed sheet with a forgery preventing function by a similar method.

1. A printer output image forming method comprising the steps of:
preparing image data including a background pattern;
preparing reproduction-restraining pattern data including a reproduction-restraining pattern;
combining the image data and the reproduction-restraining pattern data to form a composite image data; and
transferring a composite image including the background pattern and the reproduction-restraining pattern on the basis of the composite image data on an image-receiving sheet;
wherein the transferred composite image is copied such that the reproduction-restraining pattern stands out against the background pattern.

2. The printer output image forming method according to claim 1, wherein
the composite image is transferred to the image-receiving sheet by an on-demand printer system using a thermal transfer printing method, an ink-jet printing method or an electrophtographic recording method.

3. The printer output image forming method according to claim 1, wherein
the reproduction-restraining pattern is formed by combining dense and coarse arrangements of lines or dots, or by combining dots having different shades.

4. The printer output image forming method according to claim 1, wherein
an additional reproduction-restraining pattern is printed beforehand on a front or a back surface of the image-receiving sheet.

5. The printer output image forming method according to claim 1 further
comprising the step of forming an overcoating layer on the image-receiving sheet;
wherein an additional reproduction-restraining pattern is printed beforehand on the overcoating layer.

6. The printer output image forming method according to claim 4, wherein
the additional reproduction-restraining pattern is formed from lines or dots finer than the transferred reproduction-restraining pattern.

7. The printer output image forming method according to claim 5, wherein
the overcoating layer formed on the image-receiving sheet has a hologram transfer part.

8. The printer output image forming method according to claim 1, wherein
the reproduction-restraining pattern and the background pattern are formed by transferring dyes or pigments having different characteristics, respectively.

9. The printer output image forming method according to claim 1, wherein
the reproduction-restraining pattern includes a warning message, date of issue, serial number, a designation, a logo or a concealed picture.

10. A printer output image forgery preventing method comprising the steps of:
forming an image having an image pattern on an image-receiving sheet by a thermal transfer printing method; and
superposing a transparent sheet carrying a predetermined discrimination pattern on the image formed on the image-receiving sheet such that the discrimination pattern is caused to appear by a moiré effect of superposition of the predetermined discrimination pattern on the image formed on the image-receiving sheet.

11. The printer output image forgery preventing method according to claim 10, wherein
the image formed on the image-receiving sheet further includes a reproduction-restraining pattern.

12. The printer output image forgery preventing method according to claim 10, wherein
the discrimination pattern includes a warning message, date of issue, serial number, a designation, a logo or a concealed picture.

13. A printer output image forgery preventing method of preventing the forgery of a printer output image formed on a recording sheet by a thermal transfer printing method, using fluorescent colors that cannot be reproduced by ordinary printers for forming the printer output image.

14. A printer output image forming apparatus comprising:
a pattern data combining means for combining input image data including a background pattern, and a reproduction-restraining pattern data including that of a reproduction-restraining pattern to obtain a composite image data; and
an output unit that provides the composite image data and prints a composite image including the background pattern and the reproduction-restraining pattern.
